(19) United States
(12) Patent Application Publication
(10) Pub. No.: US 2026/0268774 A1
(43) Pub. Date: Sep. 10, 2026

(54) SYSTEM FOR ACCIDENT NOTIFICATION

(71) Applicant: Sun Ouk HWANG, Seoul (KR)

(72) Inventor: Sun Ouk HWANG, Seoul (KR)

(21) Appl. No.: 19/555,143

(22) Filed: Mar. 3, 2026

(30) Foreign Application Priority Data
Mar. 5, 2025 (KR) 10-2025-0027898

(51) Int. Cl. G08G 1/16; G03H 1/00; G07C 5/00; G07C 5/08; G08G 1/0967

(52) U.S. Cl. CPC G08G 1/162; G03H 1/0005; G07C 5/008; G07C 5/0825; G08G 1/096725; G08G 1/166

(57) ABSTRACT

A system for accident notification is disclosed herein. The system includes a first terminal device including a detection module configured to acquire status information of a vehicle and a controller configured to determine whether a vehicle accident has occurred or not based on the status information of the vehicle, and an accident notification device configured to communicate with the first terminal device using wireless communication. The controller controls the accident notification device to display at least one image.

### CROSS-REFERENCE TO RELATED APPLICATION

This application claims priority to and benefits of Korean Patent Application 10-2025-0027898 under 35 U.S.C. § 119, filed on Mar. 5, 2025, in the Ministry of Intellectual Property (MOIP) of the Republic of Korea, the disclosure of which is incorporated by reference herein in its entirety.

### BACKGROUND

### 1. Field

The present disclosure relates to a system for accident notification, and more specifically, to a system for accident notification that can prevent secondary accidents by providing accident notification and generating a warning sound using an accident notification device.

### 2. Description of the Related Art

With population growth and the increase in the number of vehicles on the road, traffic accidents are on the rise. While traffic accidents on the road can cause significant damage on their own, the traffic accidents can also exacerbate the damage by triggering secondary accidents. The secondary accidents refers to accidents in which a vehicle or its occupants are struck by a subsequent vehicle after a preceding accident or a breakdown.

To prevent these secondary accidents, the driver of the accident vehicle are required to install a warning sign (e.g., a warning triangle) at least 100 meters behind the accident vehicle during the day. And the driver of the accident vehicle are required to install a flashing light, visible from 500 meters behind the accident vehicle, along with the warning sign, at least 200 meters behind the accident vehicle during the night.

However, on roads with high traffic volume, especially highways, it is practically impossible for the driver of the accident vehicle to quickly and safely install such a warning sign. Additionally, it is almost impossible to install the warning sign if the driver of the accident vehicle is unconscious due to the traffic accidents.

### SUMMARY

One or more embodiments of the present disclosure provide a system for accident notification capable of providing rapid accident notification.

One or more embodiments of the present disclosure provide the system for accident notification capable of improving the visibility of accident notification provided to surrounding vehicles.

One or more embodiments of the present disclosure provide the system for accident notification capable of preventing secondary accidents.

In one or more embodiments of the present disclosure, a system for accident notification is provided. The system may comprise a first terminal device including a detection module configured to acquire status information of a vehicle and a controller configured to determine whether a vehicle accident has occurred or not based on the status information of the vehicle, and an accident notification device configured to communicate with the first terminal device using wireless communication. The controller may control the accident notification device to display at least one image.

In an embodiment, the controller may control the accident notification device to display a holographic image in a space above the vehicle.

In an embodiment, the controller may control the accident notification device to fly a first distance from the vehicle in a first direction, and the first direction may be an upward direction relative to the vehicle.

In an embodiment, the controller may adjust the first distance so that a sum of the first distance and a second distance is less than a third distance between the vehicle and an obstacle located above the vehicle, and the second distance may be a distance between the accident notification device and a position where the holographic image is displayed.

In an embodiment, the controller may control the accident notification device to move a predetermined horizontal flight distance from the vehicle in a second direction different from the first direction.

In an embodiment, the horizontal flight distance may have different values depending on daytime and nighttime.

In an embodiment, the horizontal flight distance during the daytime may be smaller than the horizontal flight distance during nighttime.

In an embodiment, the controller may control the accident notification device to display the at least one image on a surface of a road on which the vehicle is located.

In an embodiment, the controller may control the accident notification device to generate a warning sound.

In an embodiment, the controller may determine whether to generate the warning sound from the accident notification device based on speed information of a rear vehicle.

In an embodiment, the controller may control a flight distance of the accident notification device based on environment information about a surrounding environment of the vehicle.

In an embodiment, the controller may control a wavelength of the at least one image based on environment information about a surrounding environment of the vehicle.

In an embodiment, the first terminal device may be mounted on the vehicle.

In an embodiment, the accident notification device may be detachably connected to the vehicle.

In an embodiment, the vehicle may comprise at least one groove recessed from a top surface of a sunroof of the vehicle. The at least one groove may have a shape corresponding to a shape of the accident notification device. The accident notification device may be connected to the vehicle by being inserted into the at least one groove.

In an embodiment, the accident notification device may be located in a trunk of the vehicle.

In an embodiment, the accident notification device may be an unmanned aerial vehicle.

In an embodiment, the controller may provide accident information to at least one surrounding vehicle.

In an embodiment, the controller may control a speed of at least one surrounding vehicle.

In an embodiment, the at least one surrounding vehicle may be an autonomous vehicle.

Details of other embodiments are included in the detailed description and drawings.

According to one or more embodiments of the present disclosure, when a specific event (e.g., a traffic accident, a vehicle fire, a broken-down vehicle, etc.) occurs in the vehicle, the system for accident notification may display (or output) information for the accident notification around the vehicle using an accident notification device and/or generate (or output) a warning sound (or an alert sound, a notification sound, a guidance sound). Accordingly, rapid accident notification can be provided.

According to one or more embodiments of the present disclosure, the system for accident notification may display or output the information for the accident notification using a display module included in the accident notification device. Accordingly, the visibility of the information for the accident notification provided to the surrounding vehicles or people can be improved.

According to one or more embodiments of the present disclosure, the system for accident notification may generate or output the warning sound (or the alert sound, the guidance sound, etc.) for notifying the accident using a sound generator included in the accident notification device. Accordingly, surrounding vehicles or people can more effectively recognize accidents.

Therefore, the secondary accidents that may occur after a primary accident can be prevented more effectively.

However, the effects of the present disclosure are not limited to the examples provided above, and a variety of other effects are included within the present disclosure, which can be further expanded within the scope of the present disclosure without departing from its principles.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

FIG. 1 is a view illustrating a system according to one or more embodiments of the present disclosure.

FIG. 2A is a view illustrating an example of the system of FIG. 1.

FIG. 2B is a view illustrating an example of the system of FIG. 1.

FIG. 2C is a view illustrating an example of the system of FIG. 1.

FIG. 3 is a view illustrating an example of an accident notification device included in the system of FIG. 1.

FIG. 4 is a block diagram illustrating the system according to one or more embodiments of the present disclosure.

FIG. 5 is a view for describing an example of an operation of the system of FIG. 4.

FIGS. 6A and 6B are views for describing an example of an operation of the system of FIG. 4.

FIGS. 7A and 7B are views for describing an example of an operation of the system of FIG. 4.

FIG. 8 is a view for describing an example of an operation of the system of FIG. 4.

FIG. 9 is a view illustrating a system according to one or more embodiments of the present disclosure.

### DETAILED DESCRIPTION

In the drawings, the thickness of certain lines, layers, components, elements or features may be exaggerated for clarity. It will be understood that, although the terms “first”, “second”, etc. may be used herein to describe various elements, these elements should not be limited by these terms. These terms are only used to distinguish one element from another element. Thus, a “first” element discussed below could also be termed a “second” element without departing from the teachings of the disclosure. As used herein, the singular forms are intended to include the plural forms as well, unless the context clearly indicates otherwise.

It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof.

In the entire specification, when an element is referred to as being “connected” or “coupled” to another element, it can be directly connected or coupled to the another element or be indirectly connected or coupled to the another element with one or more intervening elements interposed therebetween.

Further, an expression that an element such as a layer, region, substrate or plate is placed “on” or “above” another element indicates not only a case where the element is placed “directly on” or “just above” the other element but also a case where a further element is interposed between the element and the other element.

In the specification and the claims, the phrase “at least one of” is intended to include the meaning of “at least one selected from the group of” for the purpose of its meaning and interpretation. For example, “at least one of A and B” may be understood to mean “A, B, or A and B.”

Hereinafter, embodiments of the disclosure will be described in more detail with reference to the accompanying drawings. Throughout the drawings, the same reference numerals are given to the same elements, and their descriptions will be omitted.

### System According to Various Embodiments of the Present Disclosure

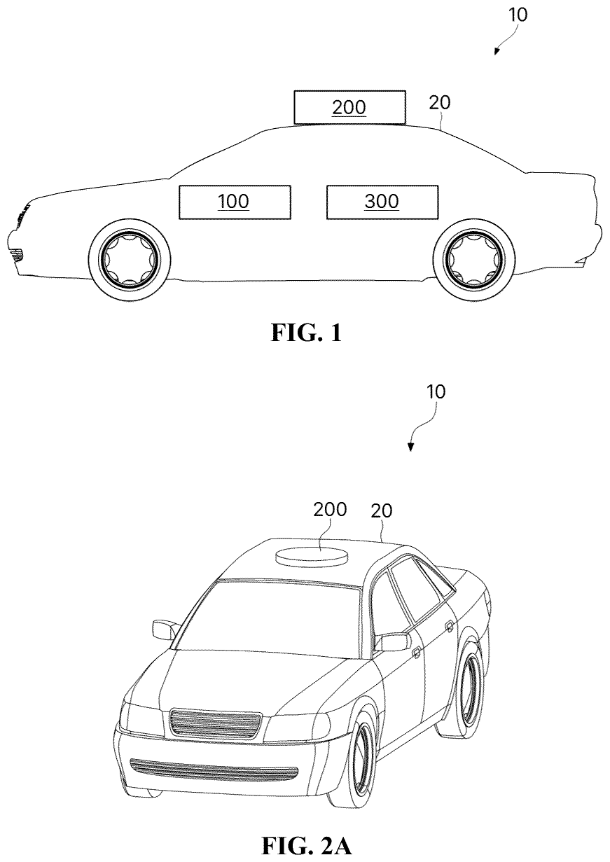

FIG. 1 is a view illustrating a system according to one or more embodiments of the present disclosure.

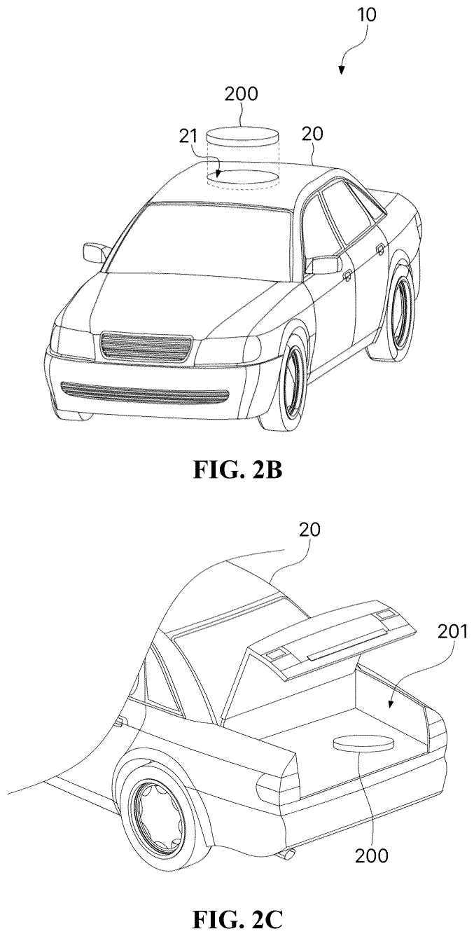

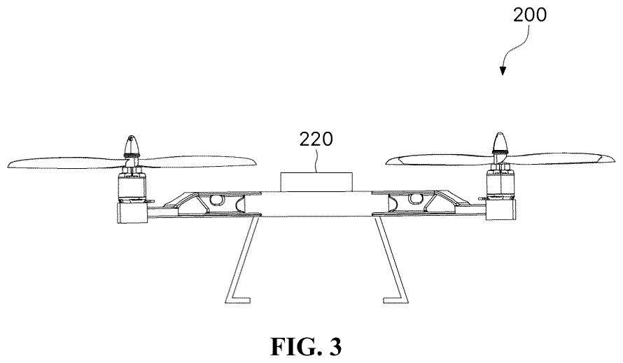

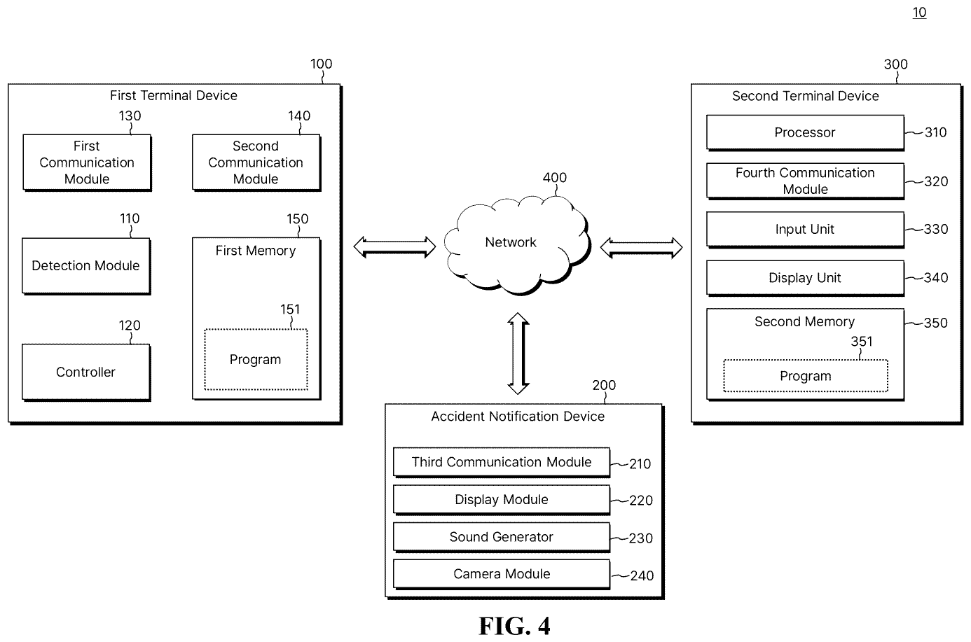

FIG. 2A is a view illustrating an example of the system of FIG. 1.

FIG. 2B is a view illustrating an example of the system of FIG. 1.

FIG. 2C is a view illustrating an example of the system of FIG. 1.

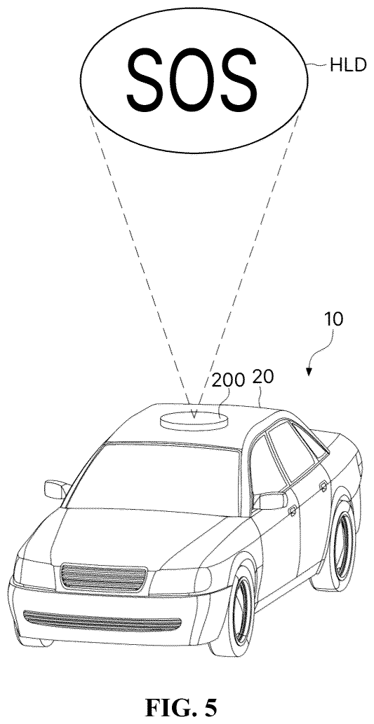

FIG. 3 is a view illustrating an example of an accident notification device included in the system of FIG. 1.

Referring to FIG. 1, the system 10 according to embodiments of the present disclosure may display (or output) information for the accident notification using a display module 220 (e.g., a laser lighting device, etc.) included in an accident notification device 200 and/or generate (or output) a warning sound (or an alert sound, a notification sound, a guidance sound) using a sound generator 230 included in the accident notification device 200 to provide the accident notification to the surrounding vehicles or people when a specific event (e.g., a traffic accident, a vehicle fire, a broken-down vehicle, etc.) occurs for a vehicle 20. The system 10 may be referred to as an accident notification system.

In an embodiment, the system 10 may be applied to a vehicle (e.g., the vehicle 20), but is not limited thereto. For example, the system 10 may be applied not only to the vehicle, but also to various other means of transportation, such as motorcycles, bicycles, and electric kickboards.

In an embodiment, the system 10 may comprise a first terminal device 100, the accident notification device 200, and a second terminal device 300.

The first terminal device 100 may be mounted on (or connected to) the vehicle 20. For example, the first terminal device 100 may be referred to as a vehicle terminal device. However, the embodiment of the present disclosure is not limited thereto, and the first terminal device 100 may also be implemented as part of the vehicle 20.

The accident notification device 200 may be controlled by the first terminal device 100 and/or the second terminal device 300.

For example, under the control of the first terminal device 100 and/or the second terminal device 300, the accident notification device 200 may display or output the information for the accident notification. For example, the accident notification device 200 may comprise the display module 220. And the accident notification device 200 may display (or output) a stereoscopic image in a hologram form in a space above the vehicle 20 using the display module 220. For example, the stereoscopic image may include a still image or video. However, the embodiment of the present disclosure is not limited thereto, and the accident notification device 200 may display (or output) a planar image on a surface of the road on which the vehicle 20 is located. For example, the planar image may include a symbol image or a text image.

In addition, under the control of the first terminal device 100 and/or the second terminal device 300, the accident notification device 200 may generate the warning sound to inform the surrounding vehicles or people of the accident using the sound generator 230.

The accident notification device 200 may be connected (or coupled, mounted, attached) to the vehicle 20. For example, the accident notification device 200 may be detachably connected to the vehicle 20, for example, may be connected to the vehicle 20 so as to be attachable or detachable to the vehicle 20.

For example, referring to FIG. 2A, the accident notification device 200 may be connected (or coupled, mounted, attached) to a sunroof of the vehicle 20.

For example, referring to FIG. 2B, the vehicle 20 may comprise at least one groove 21 the groove 21 may be formed by removing at least a portion of the sunroof to correspond to a shape of the accident notification device 200, and the accident notification device 200 may be inserted into the groove 21 formed on the sunroof of the vehicle 20. As an example, the groove 21 may be recessed from a top surface of the sunroof, the groove 21 may have a shape corresponding to the shape of the accident notification device 200, and the accident notification device 200 may be connected to the vehicle 20 by being inserted into the groove 21.

For example, referring to FIG. 2C, the accident notification device 200 may be located (or mounted) in a trunk 201 of the vehicle 20.

According to an embodiment, when the accident notification device 200 is located in the trunk 201 of the vehicle 20 as illustrated in FIG. 2C, the first terminal device 100 may control the trunk 201 to be opened when the accident occurs.

However, the embodiment of the present disclosure is not limited thereto, and the accident notification device 200 may be connected (or coupled, mounted, attached) to various locations (e.g., seat, bonnet, etc.) of the vehicle 20.

In an embodiment, under the control of the first terminal device 100 and/or the second terminal device 300, the accident notification device 200 may be separated (or detached) from the vehicle 20 and the accident notification device 200 may fly.

For example, referring further to FIG. 3, the accident notification device 200 may be implemented as an unmanned aerial vehicle (UAV) (e.g., a drone, etc.). For example, the drone, which is the unmanned aerial vehicle, is an aircraft that is controlled remotely from the ground without a pilot directly boarding the aircraft, and the drone can float in the air by a rotation of a propeller and is designed to be easily remotely controlled from a long distance. Therefore, the accident notification device 200 may communicate with the first terminal device 100 and/or the second terminal device 300 through a wireless communication method or the like, and the accident notification device 200 may fly under the control of the first terminal device 100 and/or the second terminal device 300, and may display (or output) the information for accident notification and/or generate (or output) the warning sound while in the flight state.

Referring to FIG. 1, the second terminal device 300 may be a terminal device of a driver and/or passenger (hereinafter referred to as “user”) aboard the vehicle 20. For example, the second terminal device 300 may be a display device such as a smart phone or a wearable device such as a smart watch. For example, the second terminal device 300 may also be referred to as a user terminal device or a passenger terminal device.

However, the embodiment of the present disclosure is not limited thereto, and the second terminal device 300 may be implemented as a remote control key of the vehicle 20 capable of remote communication with the first terminal device 100 and/or the accident notification device 200 via a wireless communication, or as a remote control key of the accident notification device 200.

In an embodiment, the first terminal device 100, the accident notification device 200, and the second terminal device 300 may communicate with each other. For example, the first terminal device 100 may communicate with at least one of the accident notification device 200 and the second terminal device 300. In addition, the accident notification device 200 may communicate with at least one of the first terminal device 100 and the second terminal device 300. In addition, the second terminal device 300 may communicate with at least one of the first terminal device 100 and the accident notification device 200.

More specifically, in an embodiment, when the first terminal device 100 detects that the specific event (e.g., the traffic accident, the vehicle fire, the broken-down vehicle, etc.) has occurred with respect to the vehicle 20, the first terminal device 100 may establish a communication connection with the accident notification device 200. For example, the first terminal device 100 may establish a communication connection with the accident notification device 200 via wireless communication, but is not limited thereto.

In this case, the first terminal device 100 may communicate with the accident notification device 200 and control the accident notification device 200. For example, under the control of the first terminal device 100, the accident notification device 200 may display (or output) the information for the accident notification and/or generate (or output) the warning sound, and may also perform a flight operation.

In an embodiment, the first terminal device 100 may establish a communication connection with the second terminal device 300 when the first terminal device 100 detects that the specific event (e.g., the traffic accident, the vehicle fire, the broken-down vehicle, etc.) has occurred with respect to the vehicle 20. For example, the first terminal device 100 may establish a communication connection with the second terminal device 300 via wireless communication, but is not limited thereto.

In this case, the first terminal device 100 may control the second terminal device 300 so that the accident location and accident information are transmitted in real time from the second terminal device 300 to an accident management server (e.g., fire station, police station, control center, or disaster center, etc.). Also, the first terminal device 100 may control the second terminal device 300 so that the accident location and the accident information are transmitted in real time from the second terminal device 300 to another terminal device via preset contact information (e.g., contact information of the user's family or acquaintances, etc.). Accordingly, when the specific event (e.g., the traffic accident, the vehicle fire, the broken-down vehicle, etc.) occurs, a report of the specific event can be quickly received to the accident management server, and even if the user is unconscious due to the specific event, the accident location and the accident information can be transmitted in real time from the second terminal device 300 by the control of the first terminal device 100. However, the embodiment of the present disclosure is not limited thereto, and the first terminal device 100 may also transmit the accident location and the accident information in real time directly to the accident management server and/or the another terminal device.

Additionally, the second device 300 may establish a communication connection with the accident notification device 200. For example, the second device 300 may establish a communication connection with the accident notification device 200 via wireless communication, but this is not limited thereto.

In this case, the user may directly control the accident notification device 200 using the second terminal device 300. For example, the user may control the accident notification device 200 to display (or output) the information for accident notification and/or generate (or output) the warning sound using the second terminal device 300, and may also control the accident notification device 200 to perform the flight operation.

Accordingly, the system 10 according to embodiments of the present disclosure may display (or output) the information for the accident notification about the vehicle 20 using the accident notification device 200 and/or generate (or output) the warning sound (or the alert sound, the notification sound, the guidance sound) to provide the accident notification to surrounding vehicles or people when the specific event (e.g., the traffic accident, the vehicle fire, the broken-down vehicle, etc.) occurs with respect to the vehicle 20. Therefore, when the specific event occurs with respect to the vehicle 20, the system 10 can quickly provide the accident notification.

In addition, the system 10 may display (or output) the information for the accident notification using the display module 220 (e.g., a laser lighting device, etc.) included in the accident notification device 200, so that the visibility of the information for the accident notification provided to the surrounding vehicles or people can be improved.

In addition, the system 10 may generate (or output) the warning sound (or the alert sound, the guidance sound, etc.) for notifying the accident using the sound generator 230 included in the accident notification device 200, so that surrounding vehicles or people can more effectively recognize accidents.

Therefore, the secondary accidents that may occur after a primary accident can be prevented more effectively.

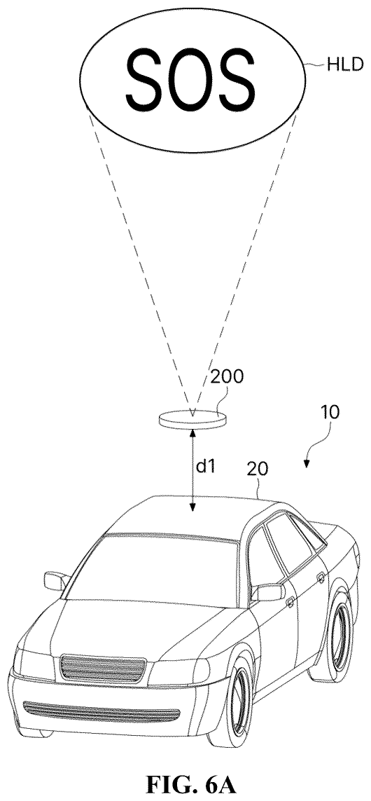

FIG. 4 is a block diagram illustrating the system according to one or more embodiments of the present disclosure.

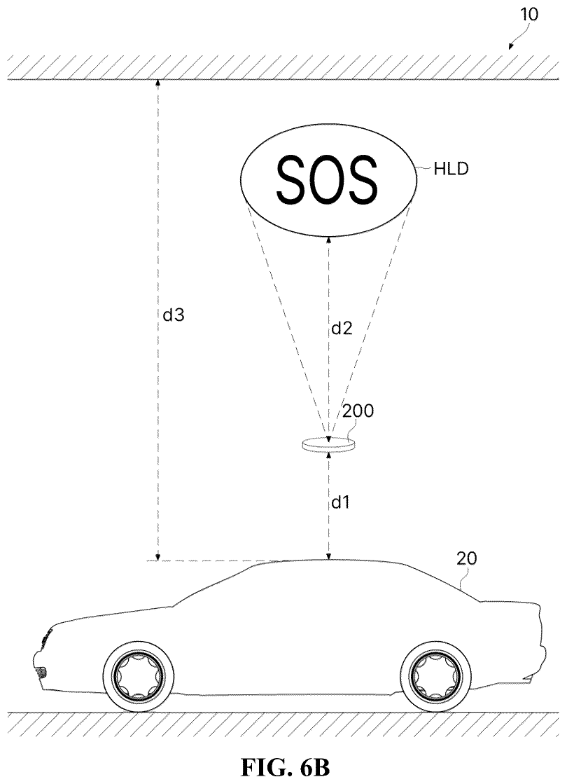

FIG. 5 is a view for describing an example of an operation of the system of FIG. 4.

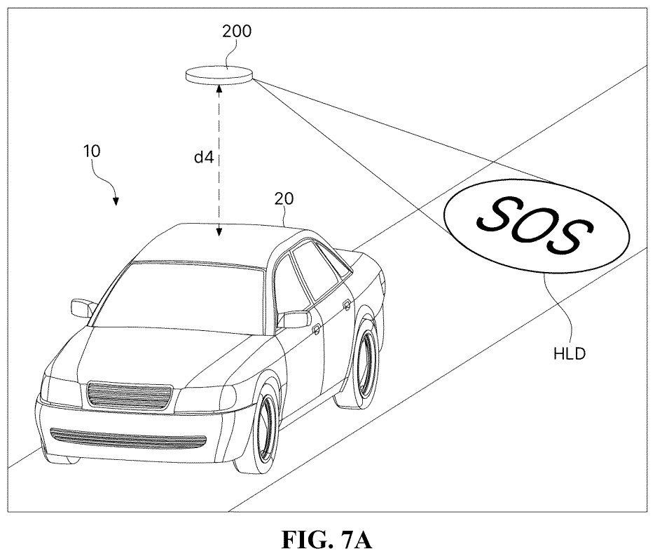

FIGS. 6A and 6B are views for describing an example of an operation of the system of FIG. 4.

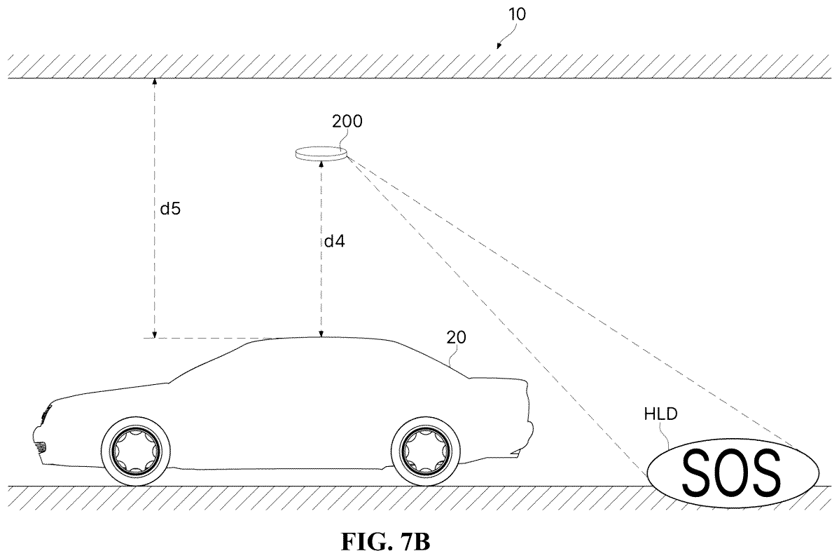

FIGS. 7A and 7B are views for describing an example of an operation of the system of FIG. 4.

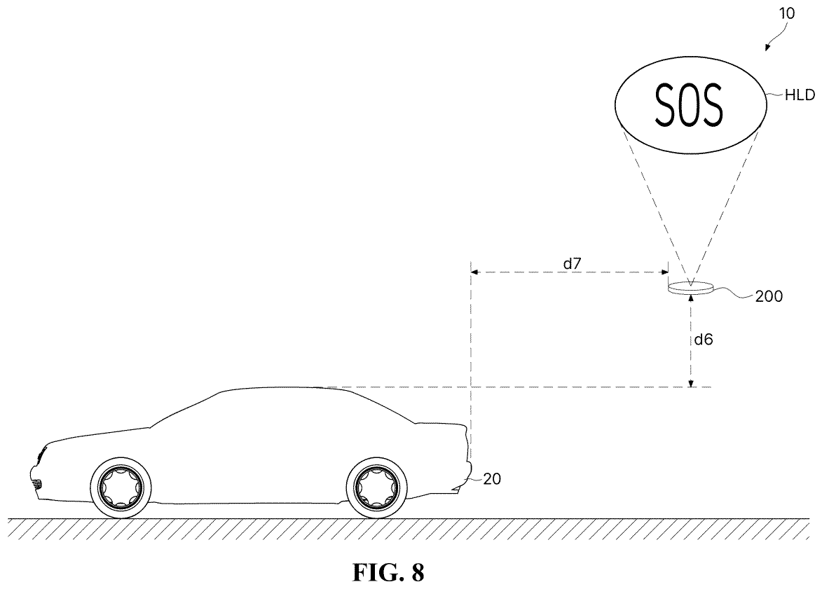

FIG. 8 is a view for describing an example of an operation of the system of FIG. 4.

Referring to FIG. 4, the system 10 according to embodiments of the present disclosure may include the first terminal device 100, the accident notification device 200, the second terminal device 300, and a network 400.

For example, the first terminal device 100, the accident notification device 200, and/or the second terminal device 300 may communicate with each other via the network 400 (e.g., a short-range wireless communication network and/or a long-range wireless communication network) in a network environment. For example, commands or data may be transmitted or received between the first terminal device 100, the accident notification device 200, and/or the second terminal device 300 via the network 400. In some embodiments, the first terminal device 100, the accident notification device 200, and/or the second terminal device 300 may also communicate with other electronic devices and/or other servers via the network 400.

The first terminal device 100 may comprise a detection module 110, a controller 120, a first communication module 130, a second communication module 140, and a first memory 150.

In some embodiments, the detection module 110, the controller 120, the first communication module 130, the second communication module 140, and the first memory 150 included in the first terminal device 100 may be electrically and/or physically connected to each other. Meanwhile, although it is illustrated in FIG. 4 that the first terminal device 100 comprises the detection module 110, the controller 120, the first communication module 130, the second communication module 140, and the first memory 150, but is not limited thereto. For example, the first terminal device 100 may be implemented by omitting at least one of the above-described components or further including other components (e.g., a power management module, a battery, etc.) other than the above-described components.

The detection module 110 may detect the status of the vehicle 20 and acquire status information of the vehicle 20. For example, the status information of the vehicle 20 may include at least one of speed information of the vehicle 20, interior temperature information of the vehicle 20, air quality information of the vehicle 20, distance information from surrounding vehicles, captured image information in the vehicle 20, airbag operation detection information of the vehicle 20, and tire pressure information of the vehicle 20.

In an embodiment, the detection module 110 may include at least one of an acceleration sensor, a gyroscope sensor, a proximity sensor, a temperature sensor, air quality detection sensor, an airbag sensor, a tire pressure sensor, an impact sensor, and a camera.

For example, the accelerometer sensor may be a sensor that measures the acceleration or impact intensity of the vehicle 20, and the gyroscope sensor may be a sensor that recognizes six directions by adding rotation to each of the existing accelerometer sensors, thereby helping to recognize more detailed and precise movements.

In addition, the proximity sensor may be a sensor for detecting the proximity of surrounding vehicles, the temperature sensor may be a sensor for measuring the temperature inside the vehicle 20, and the air quality detection sensor may be a sensor for measuring the carbon dioxide (CO₂) concentration inside the vehicle 20.

In addition, the airbag sensor may be a sensor that detects whether an airbag of the vehicle 20 is activated, and the tire pressure sensor may be a sensor that measures and detects the tire pressure of tires of the vehicle 20.

In addition, the impact sensor may be a sensor for detecting the intensity of an impact on the vehicle 20, and whether the airbag of the vehicle 20 is activated may be determined based on the intensity detected by the impact sensor.

In addition, the camera may capture at least one image of the inside of the vehicle 20, for example, images of the user riding in the vehicle 20.

However, the embodiment of the present disclosure is not limited thereto, and the detection module 110 may further include a geomagnetic sensor for detecting the position of the vehicle 20, a gravity sensor, and a lane departure detection sensor for detecting lane departure of the vehicle 20.

For example, the geomagnetic sensor may be a sensor for detecting the position of the vehicle 20, the gravity sensor may be a sensor for detecting the direction in which gravity acts on the vehicle 20, and the lane departure detection sensor may be a sensor for detecting whether the vehicle 20 is driving normally without departing from its lane.

However, the embodiment of the present disclosure is not limited thereto, and the detection module 110 may detect various status information through various sensors that detect the status of the vehicle 20 and the status of the user riding in the vehicle (20).

When the status of the vehicle 20 is detected by the detection module 110, the controller 120 may determine whether a vehicle accident has occurred or not based on the status information of the vehicle 20.

For example, if it is detected that the driving speed of the vehicle 20 detected through the detection module 110 has decelerated below a first threshold speed within a predetermined time or has accelerated above a second threshold speed within the predetermined time, the controller 120 may determine that the vehicle accident has occurred.

Also, for example, if a distance between the vehicle 20 and at least one surrounding vehicle is detected to be less than a predetermined threshold distance through the detection module 110, the controller 120 may determine that the vehicle accident has occurred.

Also, for example, if the temperature inside the vehicle 20 detected through the detection module 110 is higher than a predetermined threshold temperature, the controller 120 may determine that the vehicle accident has occurred.

Also, for example, if the carbon dioxide (CO₂) concentration inside the vehicle 20 detected through the detection module 110 is higher than a predetermined threshold concentration, the controller 120 may determine that the vehicle accident has occurred.

Also, for example, if an event in which the airbag installed in the vehicle 20 is activated is detected by the detection module 110, the controller 120 may determine that the vehicle accident has occurred.

Also, for example, if an event in which the tire pressure of the tires of the vehicle 20 is below a predetermined threshold pressure by the detection module 110, the controller 120 may determine that the vehicle accident has occurred.

Also, for example, if an event of the lane departure is detected by the detection module 110, the controller 120 may determine that the vehicle accident has occurred.

Also, for example, if the intensity of the impact on the vehicle 20 detected through the detection module 110 is greater than a predetermined threshold intensity value, the controller 120 may determine that the vehicle accident has occurred.

However, the embodiment of the present disclosure is not limited thereto, and the controller 120 may determine whether the vehicle accident has occurred or not based on two or more status information detected by the detection module 110. For example, if the number of events detected by the detection module 110 among the plurality of events described above is greater than a predetermined number, the controller 120 may determine that the vehicle accident has occurred.

The controller 120 may perform various data processing or operations to perform the aforementioned operations by executing software (e.g., program 151). For example, the controller 120 may perform the aforementioned operations using at least one artificial intelligence model, but is not limited thereto. In an embodiment, as at least a part of the data processing or operations, the controller 120 may store commands or data received from other components (e.g., the detection module 110, the first communication module 130, and/or the second communication module 140) in a volatile memory, process the commands or data stored in the volatile memory, and store a result data in non-volatile memory. For example, the first memory 150 may include at least one volatile memory or at least one non-volatile memory.

The first communication module 130 and the second communication module 140 may support the establishment of a direct (e.g., wired) communication channel or a wireless communication channel between the first terminal device 100 and the accident notification device 200 or the first terminal device 100 and the second terminal device 300, and the performance of communication through the established communication channel.

The first communication module 130 and the second communication module 140 may operate independently from other components and may comprise one or more communication processors that support a direct communication (e.g., wired communication) or a wireless communication.

In an embodiment, The first communication module 130 and the second communication module 140 may comprise a wireless communication module (e.g., a cellular communication module, a short-range wireless communication module, or a global navigation satellite system (GNSS) communication module) or a wired communication module (e.g., a local area network (LAN) communication module, or a power line communication module). Any of these communication modules may communicate with the external electronic device via a short-range communication network such as Bluetooth™, Wi-Fi (wireless fidelity) direct, or IrDA (infrared data association), or a long-range communication network such as a legacy cellular network, a 5G network, a next-generation communication network, the Internet, or a computer network (e.g., a local area network or a wide area network). These various types of communication modules may be integrated into a single component (e.g., a single chip) or implemented as multiple separate components (e.g., multiple chips).

The first communication module 130 may communicate with the accident notification device 200 using wireless communication, and the second communication module 140 may communicate with the second terminal device 300 using wireless communication.

In some embodiments, the first communication module 130 and the second communication module 140 may be integrated into a single communication module.

The first memory 150 may store various data used by at least one component (e.g., the detection module 110 or the controller 120) of the first terminal device 100. The data may include, for example, input data or output data for software (e.g., the program 151) and commands related thereto.

In an embodiment, the first memory 150 may store a learned model. For example, at least some of the program 151 stored on the first memory 150 may be learned models. Such learning (or training) may be performed, for example, in the first terminal device 100 itself on which the artificial intelligence is performed, or may be performed through a separate server. Accordingly, various components (e.g., the detection module 110, the controller 120, etc.) included in the first terminal device 100 may use the learned model by executing the program 151.

The program 151 may be stored as software in the first memory 150 and may include, for example, an operating system, middleware, or an application.

In an embodiment, instructions related to operations of the first terminal device 100 may be stored on the first memory 150. For example, at least one of instructions, an algorithm, a data structure, a program code, and an application program that can be read by the detection module 110 and/or the controller 120 may be stored on the first memory 150.

The accident notification device 200 may comprise a third communication module 210, the display module 220, the sound generator 230, and a camera module 240.

In some embodiments, the third communication module 210, the display module 220, the sound generator 230, and the camera module 240 included in the second terminal device 200 may be electrically and/or physically connected to each other. Meanwhile, although it is illustrated in FIG. 4 that the second terminal device 200 comprises the third communication module 210, the display module 220, the sound generator 230, and the camera module 240, but is not limited thereto. For example, the second terminal device 200 may be implemented by omitting at least one of the above-described components or further including other components (e.g., a power management module, a battery, etc.) other than the above-described components.

The third communication module 210 may support the establishment of a direct (e.g., wired) communication channel or a wireless communication channel between the first terminal device 100 and the accident notification device 200 or the second terminal device 300 and the accident notification device 200, and the performance of communication through the established communication channel. For example, the third communication module 210 may be implemented as a communication module substantially identical to the first communication module 130 or the second communication module 140 described above.

The display module 220 may display or output at least one image (e.g., a still image or video) including the information related to the accident notification. For example, the display module 220 may include a laser. That is, the display module 220 may be a laser lighting device, but is not limited thereto. For example, the display module 220 may also include various displays (e.g., an LED, a projector, etc.) to provide the information for the accident notification as visual information.

The sound generator 230 may output audio signals to the outside of the accident notification device 200. For example, the sound generator 230 may generate and output the warning sound (or the alert sound, the notification sound, the guidance sound) to provide the accident notification to surrounding vehicles or people. The sound generator 230 may include, for example, a speaker, but is not limited thereto.

The camera module 240 may capture still images and/or video. For example, the camera module 240 may include one or more lenses, image sensors, image signal processors, or flashes, but is not limited thereto.

In an embodiment, the accident notification device 200, for example, the display module 220, the sound generator 230, and/or the camera module 240, may communicate with the first terminal device 100 through the third communication module 210 and be controlled by the controller 120.

The second terminal device 300 may comprise a processor 310, a fourth communication module 320, an input unit 330, a display unit 340, and a second memory 350.

In some embodiments, the processor 310, the fourth communication module 320, the input unit 330, the display unit 340, and the second memory 350 included in the second terminal device 300 may be electrically and/or physically connected to each other. Meanwhile, although it is illustrated in FIG. 4 that the second terminal device 300 comprises the processor 310, the fourth communication module 320, the input unit 330, the display unit 340, and the second memory 350, but is not limited thereto. For example, the second terminal device 300 may be implemented by omitting at least one of the above-described components or further including other components (e.g., a power management module, a battery, etc.) other than the above-described components.

The processor 310 may control at least one other component (e.g., hardware or software component) connected to the processor 310 and perform various data processing or operations by executing software (e.g., program 351). In an embodiment, as at least a part of the data processing or operations, the processor 310 may store commands or data received from other components (e.g., the fourth communication module 320 or the input unit 330) in a volatile memory, process the commands or data stored in the volatile memory, and store a result data in non-volatile memory. For example, the second memory 350 may include at least one volatile memory or at least one non-volatile memory.

In an embodiment, the processor 310 may comprise a main processor (e.g., a central processing unit or an application processor) or an auxiliary processor (e.g., a graphics processing unit, a neural processing unit (NPU), an image signal processor, a sensor hub processor, or a communication processor) that can operate independently or together with the main processor. For example, when the second terminal device 300 comprise the main processor and the auxiliary processor, the auxiliary processor may use less power than the main processor or to be specialized for a given function. In some embodiments, the auxiliary processor may be implemented separately from the main processor or as a part thereof.

The processor 310 may include a hardware structure specialized for processing the artificial intelligence model. The artificial intelligence model may be generated through machine learning. The machine learning refers to learning (or training) that optimizes parameters with given data using a model composed of a plurality of parameters. Such learning (or training) may be performed, for example, in the second terminal device 300 itself on which the artificial intelligence is performed, or may be performed through a separate server.

The fourth communication module 320 may support the establishment of a direct (e.g., wired) communication channel or a wireless communication channel between the first terminal device 100 and the second terminal device 300 or the accident notification device 200 and the second terminal device 300, and the performance of communication through the established communication channel. For example, the fourth communication module 320 may be implemented as a communication module substantially identical to the first communication module 130 or the second communication module 140 described above.

The input unit 330 may receive commands or data to be used in at least one component (e.g., the processor 310) of the second terminal device 300 from an external source (e.g., the user or the passenger) of the second terminal device 300. For example, the input unit 330 may comprise a microphone, a mouse, a keyboard, a key (e.g., a button), or a digital pen (e.g., a stylus pen), but is not limited thereto.

The display unit 340 may visually provide information to an external party (e.g., the user or the passenger) of the second terminal device 300. For example, the display unit 340 may comprise a display (e.g., a display panel), a holographic device, or a projector, and may further comprise a control circuit for controlling these. Additionally, the display unit 340 may further comprise a touch screen to recognize a touch input from the user.

In an embodiment, the display unit 340 may display a graphical user interface (GUI) for receiving at least one user input (e.g., touch input, etc.).

The second memory 350 may store various data used by at least one component (e.g., the processor 310, etc.) of the second terminal device 300. The data may include, for example, input data or output data for software (e.g., the program 351) and commands related thereto.

In an embodiment, the second memory 350 may store a learned model. For example, at least some of the program 351 stored on the second memory 350 may be learned models. Such learning (or training) may be performed, for example, in the second terminal device 300 itself on which the artificial intelligence is performed, or may be performed through a separate server. Accordingly, the processor 310 may use the learned model by executing the program 351.

The program 351 may be stored as software in the second memory 350 and may include, for example, an operating system, middleware, or an application.

In an embodiment, instructions related to operations of the second terminal device 300 may be stored on the second memory 350. For example, at least one of instructions, an algorithm, a data structure, a program code, and an application program that can be read by the processor 310 may be stored on the second memory 50.

In an embodiment, when the first terminal device 100 (e.g., the controller 120) detects that the specific event (e.g., the traffic accident, the vehicle fire, the broken-down vehicle, etc.) has occurred with respect to the vehicle 20, the first communication module 130 of the first terminal device 100 and the third communication module 210 of the accident notification device 200 may be connected to each other through communication, and the controller 120 may control the accident notification device 200.

For example, referring to FIG. 5, the controller 120 may control the accident notification device 200 to display at least one image. For example, the controller 120 may control the accident notification device 200 to display (or output) the stereoscopic image (e.g., a still image or video) in the hologram form in the space above the vehicle 20. Here, as illustrated in FIG. 5, the accident notification device 200 may display (or output) the stereoscopic image while coupled to the vehicle 20. For example, the controller 120 may control the display module 220 included in the accident notification device 200 to display or output the stereoscopic image including accident information HLD in a laser holographic manner using the laser.

However, the embodiment of the present disclosure is not limited thereto, and as described with reference to FIG. 1, the third communication module 210 and the fourth communication module 320 are connected to each other, so that the user may directly control the accident notification device 200 using the second terminal device 300.

Meanwhile, in FIG. 5, the text “SOS” is displayed as the accident information HLD, but this is merely an example, and the accident information HLD may include various information related to the accident. For example, the accident information HLD may include at least one of a safety triangle-shaped symbol, the number of users (or passengers) on board the vehicle 20, personal information of the user (or passenger), the type of accident (e.g., traffic accident, vehicle fire, broken-down vehicle, etc.), the time of accident occurrence, and the degree of risk of the accident.

In some embodiments, a wavelength of the image for the accident information HLD displayed by the accident notification device 200 may be determined by considering human visibility of the image (e.g., the holographic image). For example, since humans have the greatest visibility to light having a wavelength of about 555 nm in the visible light spectrum (e.g., green light), the accident notification device 200 may control the image for the accident information HLD to have a wavelength within a first range (e.g., 530 to 570 nm).

In an embodiment, the accident notification device 200 (e.g., the controller 120) may receive environment information about the surrounding environment of the vehicle 20 from the first terminal device 100 and/or the second terminal device 300, and may control the wavelength of the image (e.g., the holographic image) for displaying the accident information HLD based on the environment information. For example, the environment information may include a first environment information about whether it is daytime or nighttime, a second environment information including weather information, a third environment information about the amount of ambient light, a fourth environment information about the distance between the vehicle 20 and a rear vehicle, etc.

For example, the accident notification device 200 may control the wavelength of the image displaying the accident information HLD based on the first environment information. For example, the accident notification device 200 may control the wavelength of the image displaying the accident information HLD depending on whether it is daytime or nighttime. For example, during the daytime, since there is strong background light from sunlight, the green light, which is most sensitive to the human cone cells, has the highest visibility, and thus the image displaying the accident information HLD may have a wavelength in the first range (e.g., 530 to 570 nm). In addition, during nighttime, since there is less background light, the cyan light, which is most sensitive to the human rod cells, has the highest visibility, and thus the image displaying the accident information HLD may have a wavelength in a second range (e.g., 505 to 510 nm).

Also, for example, the accident notification device 200 may control the wavelength of the image displaying the accident information HLD based on the second environment information. For example, the accident notification device 200 may control the wavelength of the image displaying accident information HLD based on the weather information at the time of the accident. For example, in the case of a clear day, the image displaying the accident information HLD may have the wavelength in the first range (e.g., 530 to 570 nm). In addition, in the case of a cloudy day, the image displaying the accident information HLD may have the wavelength in the second range (e.g., 505 to 510 nm). Meanwhile, the clear and the cloudy day may be classified based on total cloud cover. For example, if the total cloud cover is less than 5, it may be classified as the clear day, and if the total cloud cover is greater than 5, it may be classified as the cloudy day, but is not limited thereto.

Also, for example, the accident notification device 200 may control the wavelength of the image displaying the accident information HLD based on the third environment information. For example, the accident notification device 200 may control the wavelength of the image displaying the accident information HLD depending on the amount of light around the vehicle 20. For example, the image displaying the accident information HLD may have the wavelength in a third range (e.g., 505 to 570 nm), and the accident notification device 200 may control the wavelength of the image displaying the accident information HLD so that the wavelength of the image is higher as the amount of ambient light increases within the third range and the wavelength of the image is lower as the amount of light decreases within the third range.

Also, for example, the accident notification device 200 may control the image displaying the accident information HLD to have a wavelength within a fourth range (e.g., 630 to 650 nm) based on the weather information included in the second environment information. For example, if it is raining, foggy, and/or yellow dust is occurring, the visibility of red light may increase due to interaction with water droplets or scattering by fine particles. Accordingly, the accident notification device 200 may control the image displaying the accident information HLD to have the wavelength within the fourth range based on the second environment information if the current weather is rainy, foggy and/or yellow dust is occurring.

Also, for example, the accident notification device 200 may control the wavelength of the image displaying the accident information HLD based on the fourth environment information. For example, the accident notification device 200 may control the wavelength of the image displaying the accident information HLD based on the distance between the vehicle 20 and the rear vehicle. The fourth environment information may include information about the distance between the vehicle 20 and the closest rear vehicle based on GPS navigation information. For example, when the distance between the vehicle 20 and the rear vehicle is relatively close, for example, within 1 km, the image displaying the accident information HLD may have the wavelength in the first range (e.g., 530 to 570 nm). Also, when the distance between the vehicle 20 and the rear vehicle is relatively far, for example, more than 1 km, the image displaying the accident information HLD may have the wavelength in the fourth range (e.g., 630 to 650 nm) because atmospheric scattering is reduced.

In some embodiments, the environment information may be provided from the first terminal device 100 and/or the second terminal device 300, but is not limited thereto, and may also be provided through the accident management server (e.g., the fire station, the police station, the control center, or the disaster center, etc.).

In an embodiment, the accident notification device 200 may be implemented as the unmanned aerial vehicle (e.g., the drone) as described with reference to FIG. 3. In this case, the controller 120 may control the accident notification device 200 to be separated (or detached) from the vehicle 20 and to perform flight in order to improve the visibility of the accident information HLD for surrounding vehicles or people.

For example, referring to FIG. 6A, the controller 120 may control the accident notification device 200 to fly a first distance d1 from the vehicle 20 in a first direction. For example, the first direction may be an upward direction relative to the vehicle 20. In this way, when the accident notification device 200 displays the image including the accident information HLD while flying the first distance d1 from the vehicle 20 in the first direction (or upward direction), a height at which the image including the accident information HLD is displayed becomes higher, so that the accident information HLD can be more effectively recognized by surrounding vehicles or people.

In some embodiments, the controller 120 may control a flight distance of the accident notification device 200, for example, the first distance d1 based on the environment information about the surrounding environment of the vehicle 20.

For example, since the visibility decreases as the amount of ambient light increases, such as on the clear day or during daytime, the controller 120 may increase the value of the first distance d1 as the amount of ambient light increases.

Also, for example, since the visibility decreases as the distance between the vehicle 20 and the rear vehicle increases, the controller 120 may increase the value of the first distance d1 as the distance between the vehicle 20 and the rear vehicle increases. For example, when the distance between the vehicle 20 and the rear vehicle is less than 1 km, the controller 120 may control the accident notification device 200 to fly the first distance d1 having a first value from the vehicle 20 in the first direction, and when the distance between the vehicle 20 and the rear vehicle is 1 km or more, the controller 120 may control the accident notification device 200 to fly the first distance d1 having a second value from the vehicle 20 in the first direction. For example, the second value is greater than the first value.

In addition, referring to FIG. 6B, the controller 120 may determine whether there is an obstacle, such as a tree or a tunnel wall, above the vehicle 20 through the detection module 110 (e.g., the proximity sensor, etc.), and based on this, control the flight distance of the accident notification device 200, for example, the first distance d1. For example, when the accident notification device 200 displays the image including the accident information HLD in the first direction (e.g., the upward direction), the controller 120 may adjust (or control) the first distance d1 so that a sum of the first distance d1 and a second distance d2 is less than a third distance d3 between the vehicle 20 and the obstacle located above the vehicle 20. For example, the second distance d2 is a distance between the accident notification device 200 and a position where the image is displayed. Accordingly, the image displayed from the accident notification device 200 can be displayed normally without being obstructed by the obstacle.

Meanwhile, in FIGS. 5 to 6B, the accident notification device 200 is described as displaying the image including the accident information HLD from the vehicle 20 in the first direction (e.g., the upward direction) in the hologram form, but the embodiment of the present disclosure is not limited thereto.

For example, referring to FIG. 7A, the controller 120 may control the accident notification device 200 to fly a fourth distance d4 from the vehicle 20 in the first direction (or upward direction) and may control the accident notification device 200 to display (or output) the image including the accident information HLD on the surface of the road on which the vehicle 20 is located.

Also, for example, referring further to FIG. 7B, the controller 120 may determine whether there is the obstacle (e.g., the tree, the tunnel wall, etc.) above the vehicle 20 through the detection module 110 (e.g., the proximity sensor, etc.), and based on this, control the flight distance of the accident notification device 200, for example, the fourth distance d4. For example, when the accident notification device 200 displays the image including the accident information HLD on the surface of the road while the accident notification device 200 is flying, the controller 120 may control the fourth distance d4 so that the fourth distance d4 is smaller than the fifth distance d5 between the vehicle 20 and the obstacle (e.g., the upper wall of a tunnel).

Meanwhile, in FIGS. 6A and 6B, the accident notification device 200 is described as flying in a vertical direction (e.g., the first direction or the upward direction) relative to the surface of the road, but is not limited thereto.

For example, referring to FIG. 8, the controller 120 may control the accident notification device 200 to fly a sixth distance d6 from the vehicle 20 in the first direction (or the vertical direction, upward direction) and a seventh distance d7 from the vehicle 20 in a second direction (e.g., horizontal direction). For example, the second direction may be a direction different from the first direction, for example, a direction (e.g., horizontal direction) opposite to the driving direction of the vehicle 20. For example, for the function of a safety triangle installed in the event of a general traffic accident, the controller 120 may control the seventh distance d7 to have a value of 100 m during the daytime and a value of 200 m during the nighttime, but is not limited thereto. Meanwhile, in this case, the accident information HLD may also include the seventh distance d7. The seventh distance d7 may be referred to as a horizontal flight distance.

In an embodiment, the horizontal flight distance (e.g., the seventh distance d7) may be predetermined and the predetermined horizontal flight distance (e.g., the seventh distance d7) may have different values depending on the daytime and nighttime. For example, the horizontal flight distance (e.g., the seventh distance d7) during the daytime may be smaller than the horizontal flight distance (e.g., the seventh distance d7) during nighttime. For example, the horizontal flight distance (e.g., the seventh distance d7) during the daytime may be 100 m, and the horizontal flight distance (e.g., the seventh distance d7) during nighttime may be 200 m, but is not limited thereto.

Referring to FIG. 4, the controller 120 may control the sound generator 230 to generate (or output) the warning sound for the accident notification to surrounding vehicles or people while the accident notification device 200 (e.g., the display module 220) is displaying or outputting the image including the accident information HLD. In this way, when generating not only visually recognizable information (e.g., the accident information HLD) but also audibly recognizable information (e.g., the warning sound), the accident notification can be effectively provided to drivers of surrounding vehicles who are negligent in paying attention to the front.

In an embodiment, the controller 120 may receive speed information of the rear vehicle through GPS navigation information, etc., and control the sound generator 230 based on the speed information. For example, the controller 120 may determine whether to generate the warning sound from the accident notification device 200 (e.g., the sound generator 230) based on the speed information of the rear vehicle. For example, when the accident notification device 200 (e.g., the display module 220) is displaying or outputting the image including the accident information HLD, and the speed of the rear vehicle within a predetermined distance (e.g., 100 m) from the vehicle 20 does not decelerate, the controller 120 may control the sound generator 230 to generate (or output) the warning sound to notify surrounding vehicles or people of the accident.

In an embodiment, the accident notification device 200 may acquire image data by capturing the surrounding environment of the accident. The image data is provided to the first terminal device 100 (e.g., the controller 120) via the network 400, and the controller 120 may analyze the image data and control the display module 220 and/or the sound generator 230.

For example, the controller 120 may analyze the image data to extract the information about the distance between the rear vehicle and the vehicle 20, the environment information, and based on this, the controller 120 may control the wavelength of the image displaying the accident information HLD of the display module 220 and/or the distance (e.g., the first distance d1, the fourth distance d4 and/or the seventh distance d7) at which the accident notification device 200 flies.

In some embodiments, the image data acquired by the accident notification device 200 may be stored in at least one of the system 10, for example, the first terminal device 100, the accident notification device 200, and the second terminal device 300, and the stored image data may be utilized as accident investigation or insurance data in the future.

Meanwhile, in FIGS. 5 to 8, the accident notification device 200 is illustrated as being attached to or detached from the sunroof of the vehicle 20 and flying, but is not limited thereto. For example, as described with reference to FIG. 2B, when the accident notification device 200 is inserted into the groove 21 formed on the sunroof of the vehicle 20, the accident notification device 200 may be inserted into and attached to the groove 21 of the vehicle 20 and may be detached from the groove 21 and flying. As another example, as described with reference to FIG. 2C, when the accident notification device 200 is mounted in the trunk 201 of the vehicle 20, the first terminal device 100 may control the trunk 201 of the vehicle 20 to be opened before the accident notification device 200 performs the operation described with reference to FIGS. 5 to 8.

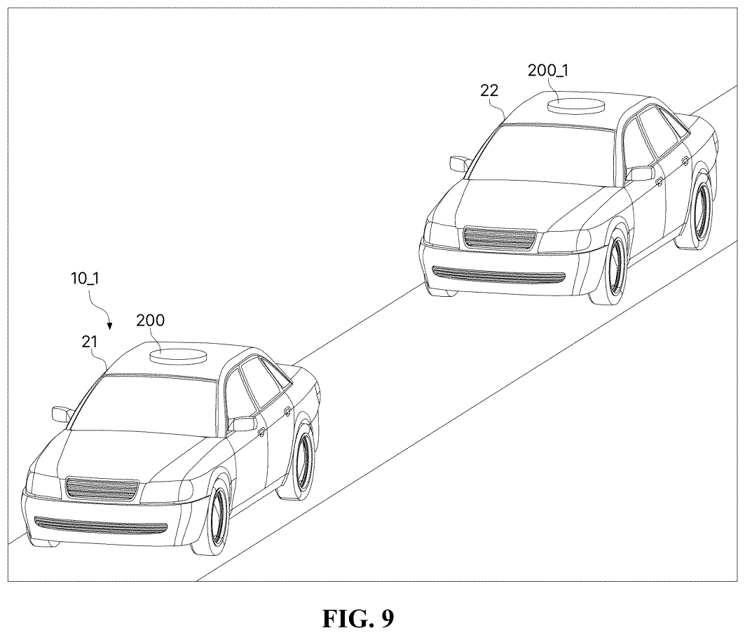

FIG. 9 is a view illustrating a system according to one or more embodiments of the present disclosure.

Referring to FIG. 9, the system 10_1 may comprise the accident notification device 200 connected (or coupled, mounted, attached) to the first vehicle 21. Meanwhile, although not illustrated in FIG. 9, as described with reference to FIGS. 1 to 8, the first terminal device 100 described with reference to FIGS. 1 to 8 may be connected (or coupled, mounted, attached) to the first vehicle 21, and the system 10_1 may further comprise the second terminal device 300. That is, the first vehicle 21 may be the vehicle 20 described with reference to FIGS. 1 to 8. In addition, the second vehicle 22 may be a vehicle surrounding the first vehicle 21, for example, the rear vehicle.

In an embodiment, when it is detected that the specific event (e.g., the traffic accident, the vehicle fire, the broken-down vehicle, etc.) occurs for the first vehicle 21, the system 10_1, for example, the first terminal device 100 may perform communication with the second vehicle 22, and/or control the navigation system or vehicle terminal included in the second vehicle 22 to output accident-related information (accident information) via the navigation operation server. For example, the accident-related information (accident information) may include the location where the accident occurred, but is not limited to.

In an embodiment, when the second vehicle 22 is an autonomous vehicle, the system 10_1, for example, the first terminal device 100 may communicate with the second vehicle 22 to control the second vehicle 22 to slow down or stop. Here, the autonomous vehicle may refer to a smart vehicle equipped with autonomous driving technology that allows the vehicle to reach its destination on its own without the driver having to directly operate the steering wheel, accelerator pedal, brakes, etc.

According to an embodiment, if an additional accident notification device (e.g., the accident notification device 200) described with reference to FIGS. 1 to 8 is also connected (or, coupled, mounted, attached) to the second vehicle 22, the first terminal device 100 of the first vehicle 21 may communicate with the additional accident notification device of the second vehicle 22 and control the additional accident notification device of the second vehicle 22 to perform the operation of the accident notification device described with reference to FIGS. 1 to 8. Accordingly, the accident notification for subsequent vehicles can be performed more effectively.

Although the embodiments of the present disclosure have been described with reference to the accompanying drawings, it will be understood by those skilled in the art to which the disclosure pertains that the embodiments may be implemented in other specific forms without changing the technical spirit and essential features of the disclosure. Therefore, it should be understood that the embodiments described above are illustrative and are not restrictive in all aspects.

1. A system for accident notification, comprising:
a first terminal device including a detection module configured to acquire status information of a vehicle and a controller configured to determine whether a vehicle accident has occurred or not based on the status information of the vehicle; and
an accident notification device configured to communicate with the first terminal device using wireless communication,
wherein the controller controls the accident notification device to display at least one image.

2. The system of claim 1,
wherein the controller controls the accident notification device to display a holographic image in a space above the vehicle.

3. The system of claim 2,
wherein the controller controls the accident notification device to fly a first distance from the vehicle in a first direction, and
wherein the first direction is an upward direction relative to the vehicle.

4. The system of claim 3,
wherein the controller adjusts the first distance so that a sum of the first distance and a second distance is less than a third distance between the vehicle and an obstacle located above the vehicle, and
wherein the second distance is a distance between the accident notification device and a position where the holographic image is displayed.

5. The system of claim 3,
wherein the controller controls the accident notification device to move a predetermined horizontal flight distance from the vehicle in a second direction different from the first direction.

6. The system of claim 5,
wherein the horizontal flight distance has different values depending on daytime and nighttime.

7. The system of claim 6,
wherein the horizontal flight distance during the daytime is smaller than the horizontal flight distance during nighttime.

8. The system of claim 1,
wherein the controller controls the accident notification device to display the at least one image on a surface of a road on which the vehicle is located.

9. The system of claim 1,
wherein the controller controls the accident notification device to generate a warning sound.

10. The system of claim 9,
wherein the controller determines whether to generate the warning sound from the accident notification device based on speed information of a rear vehicle.

11. The system of claim 1,
wherein the controller controls a flight distance of the accident notification device based on environment information about a surrounding environment of the vehicle.

12. The system of claim 1,
wherein the controller controls a wavelength of the at least one image based on environment information about a surrounding environment of the vehicle.

13. The system of claim 1,
wherein the first terminal device is mounted on the vehicle.

14. The system of claim 1,
wherein the accident notification device is detachably connected to the vehicle.

15. The system of claim 14,
wherein the vehicle comprises at least one groove recessed from a top surface of a sunroof of the vehicle,
wherein the at least one groove has a shape corresponding to a shape of the accident notification device, and
wherein the accident notification device is connected to the vehicle by being inserted into the at least one groove.

16. The system of claim 14,
wherein the accident notification device is located in a trunk of the vehicle.

17. The system of claim 1,
wherein the accident notification device is an unmanned aerial vehicle.

18. The system of claim 1,
wherein the controller provides accident information to at least one surrounding vehicle.

19. The system of claim 1,
wherein the controller controls a speed of at least one surrounding vehicle.

20. The system of claim 19,
wherein the at least one surrounding vehicle is an autonomous vehicle.
